(19) United States
(12) Patent Application Publication
(10) Pub. No.: US 2020/0088153 A1
(43) Pub. Date: Mar. 19, 2020

(54) Hydroenergetic Motor

(71) Applicant: GORAN KEPNIK S.P., Jesenice na Dolenjskem (SI)

(72) Inventor: Goran Kepnik, Jesenice na Dolenjskem (SI)

(21) Appl. No.: 16/500,228

(22) PCT Filed: Jun. 8, 2018
(86) PCT No.: PCT/SI2018/000011

§ 371 Date: Oct. 2, 2019

(30) Foreign Application Priority Data
Jun. 9, 2017 (SI) P-201700163

(51) Int. Cl. F03B 7/00

(52) U.S. Cl. CPC F03B 7/006

(57) ABSTRACT

Hydroenergetic motor is the energy converter intended to transform the hydropotential energy into the mechanical work in the form of the torque in such a way that the force of the pressure of the column of the liquid, acting on the ball (Kr) in the nozzle (S) achieves the movement of the chain (VK) with the balls (Kr) first, which is then transferred to the wheel (K) of the device. Due to the fact that the wheel (K) is not in direct contact with the fluid, and whereas, at the same time, the hydroenergetic motor according to the invention can also generate a torque with small and uneven flows, it can be used where the use of conventional hydroelectric converters is not appropriate due to the specific characteristics of the working liquids and specific hydrodynamic flow parameters, for example in sewage systems, in order to exploit the hydro-potential energy of the waste liquid of the sewage system. In those systems the use of a hydroenergetic motor according to the invention is preferred. The installation of the hydroenergetic motor with the purpose of exploiting hydropotential energy of the waste sewage fluid flowing through either one or more building objects may be done at any location in the sewer system in a way that the generator producing electricity is attached to the wheel (K). During operation, the hydroenergetic motor does not emit any byproducts into the environment and this actually makes the hydroenergetic motor the renewable source of energy.

The subject of the invention is a device that converts the hydropotential energy of the column of liquid of defined height H, into useful (exploitable) mechanical energy produced through a wheel rotation and thus achieving a torque in an original way.

The technical problem solved by the present invention is direct conversion of the hydropotential energy into mechanical energy by means of a column of liquid, which results in the increased efficiency. Considering the energy losses, mechanical and hydraulic friction and hydrodynamic losses during liquid flowing out through the nozzle are present.

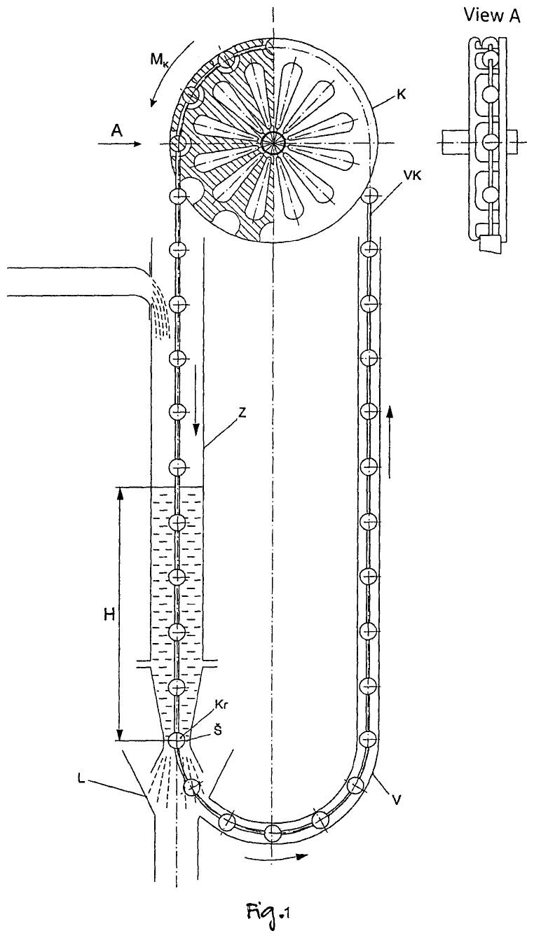

The invention will be described in FIG. 1, which shows a hydroenergetic motor according to the invention.

The hydroenergetic motor consists of: a chain (VK) with balls (Kr); a wheel (K) to which the movement of the chain (VK) is transferred to, and wherein the wheel (K) has grooves around its circumference at uniform intervals for receiving the balls (Kr); a reservoir (Z), which is preferably in the form of a vertical pipe, in which a column of the liquid of the height H is formed and to which, in its lower part, a conical attachment with a nozzle (Š) is mounted; a funnel (L) that collects the liquid flowing out of the nozzle (Š) and guiding means (V) which directs the movement of the chain (VK) so that it moves in a straight line in the guide means (V) upwards, and at the same time preventing any uncontrolled oscillations. The force of the pressure of the column of the liquid (H) acts on the ball (Kr) which is currently located in the nozzle (Š) and squeezing it out of the nozzle (Š) thus driving the chain (VK) with the balls (Kr) in the guide means (V) in the upwards direction, as is marked with the arrows. The procedure is repeated when the next ball (Kr) enters the nozzle (Š). Simultaneously a certain amount of liquid flows through the nozzle into a funnel (L). The movement of the chain (VK) is thus transferred to the wheel (K) and in this way the torque M_{K}, i.e. the rotation of the wheel (K), is achieved. In order for the ball (Kr) to slip through the nozzle (Š) it is necessary to provide the clearance between the ball (Kr) and the nozzle (Š), whereas the clearance is at least of the value that, when the ball (Kr) is located in the nozzle (Š), the ball (Kr) does not touch the nozzle (Š), so that there is no mechanical friction between the sphere (Kr) and the nozzle (Š) during the operation of the hydroenergetic motor.

All elements of the hydroenergetic motor, that is: the balls (Kr), the wheel (K), the guiding means (V), the reservoir (Z), the conical attachment with the nozzle (Š), the funnel (L), can be made out of plastic.

Apart from balls (Kr), elements of a different shape (for example, ovals) can be attached to the chain if this reduces energy losses and increases the efficiency of the engine.

The use of the hydroenergetic motor with the purpose of the exploitation of the hydropotential energy of the waste sewage liquid flowing through the sewer system of the single-one or several multi-story building is described below.

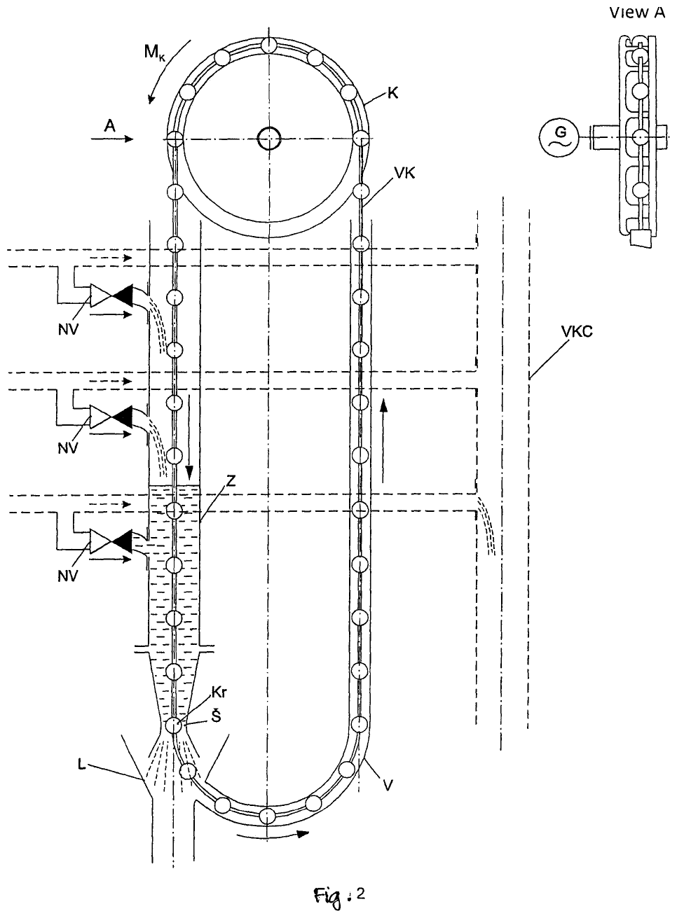

The installation scheme of the hydroenergetic motor of the invention into the sewer system of the multi-story building will be described by FIG. 2. The hydroenergetic motor built-into the sewer system of the single-one or several multi-story buildings, makes the exploitation of the hydropotential energy of the waste sewage liquid possible. In the building, in addition to the main vertical sewer pipe (VKC), the hydroenergetic motor with the reservoir (Z) is placed. Into said reservoir (Z) a waste liquid may flow through the non-return valves (NV) in the direction indicated by the solid line arrows. If the level of the waste liquid in the reservoir (Z) is above the level of the drainage pipe connection of certain floor, the non-return valve (NV) prevents the flow of the waste liquid back into the sewer system (into discharged waste pipe), thus diverting the waste liquid into the vertical sewer pipe (VKC) as shown by the dashed line arrows. As soon as the level of the waste liquid in the reservoir (Z) drops below the level of the drainage pipe connection of a certain floor the non-return valve (NV) redirects back the flow of the waste liquid into the reservoir (Z) in order to exploit the hydropotential energy of the column of the waste liquid. The wheel (K) drives a generator for the production of electricity, which can be used for various purposes (e.g. as a staircase illumination) or it can be stored in the batteries.

Due to the fact that the wheel (K) is not in direct contact with the fluid, and whereas, at the same time, the hydroenergetic motor according to the invention can also generate a torque with small and uneven flows, it can be used where the use of conventional hydroelectric converters is not appropriate due to the specific characteristics of the working liquids and specific hydrodynamic flow parameters, for example in sewage systems, in order to exploit the hydro-potential energy of the waste liquid of the sewage system. In those systems the use of a hydroenergetic motor according to the invention is preferred. The hydroenergetic motor, according to the invention can be installed at any location within the sewage system as a part of the single-one or several multi-story buildings with the purpose of exploiting hydro-potential energy of the waste sewage fluid flowing through either one or more building objects.

1. A hydroenergetic motor, as an energy converter for transforming the hydropotential energy as pressure of a column of liquid in a reservoir (Z) into mechanical energy in the form of a torque
wherein
it comprises of: a chain with balls; a wheel to which the movement of the chain is transferred to and wherein the wheel has grooves around its circumference at uniform intervals for receiving the balls; a reservoir, which may be in the form of a vertical pipe, in which a column of the liquid of the height is formed and to which, in its lower part, a conical attachment with a nozzle is mounted; a funnel that collects the liquid flowing out of the nozzle and a guiding means which directs the movement of the chain so that it moves in a straight line in the guide means upwards and prevents any uncontrolled oscillations; wherein the force of the pressure of the liquid column acts on the ball which is currently located in the nozzle and squeezing it out of the nozzle thus driving the chain with the ball in the guiding means in the upward direction and wherein the movement of the chain is transferred to the wheel, thus achieving a torque i.e. rotation of the wheel.

2. The hydroenergetic motor according to claim 1 wherein, a clearance between the ball and the nozzle is provided, whereas the clearance is at least of the value that, when the ball is located in the nozzle, the ball does not touch the nozzle, so that there is no mechanical friction between the sphere and the nozzle during the operation of the hydroenergetic motor.

3. A use of the hydroenergetic motor according to claim 1 for the electricity generation exploiting the potential energy of the waste liquid column of the sewer system flowing through the single-one or several multi-story buildings
wherein
in addition to the main vertical sewer pipe the hydroenergetic motor with the reservoir is installed into which a waste liquid flows through non-return valves and with an electric generator attached to the wheel, wherein non-return valves prevent the flow of the waste liquid from the reservoir back into the sewer system thus diverting the waste liquid into the main vertical sewer pipe; and as soon as the level of waste liquid in the reservoir drops below the level of the drainage pipe connection of a certain floor, the non-return valve redirects back the flow of the waste liquid into the reservoir of the hydroenergetic motor, wherein the hydropotential energy of the waste liquid column is converted firstly into the mechanical energy and then into the electric energy.
